(19) United States
(12) Patent Application Publication
(10) Pub. No.: US 2025/0296406 A1
(43) Pub. Date: Sep. 25, 2025

(54) AIR REGISTERS INCLUDING FIXED BLADES AND A SLIDABLE SHUTTER

(71) Applicant: Toyoda Gosei Co., Ltd., Kiyosu-shi (JP)

(72) Inventors: Roy Thorsell, Wixom, MI (US); Hideki Okigawa, Novi, MI (US)

(73) Assignee: Toyoda Gosei Co., Ltd., Kiyosu-shi (JP)

(21) Appl. No.: 18/611,823

(22) Filed: Mar. 21, 2024

(51) Int. Cl. B60H 1/34

(52) U.S. Cl. CPC B60H 1/3421

(57) ABSTRACT

An air register including a housing defining a rear opening and a front opening, a blade member provided within the housing and including a plurality of vertical blades, and a shutter located between the blade member and the front opening of the housing, the shutter being slidably movable relative to the housing. Translation of the shutter in a vehicle lateral direction controls a flow of air through the plurality of vertical blades. The blade member includes a plurality of vertical blades. Movement of the shutter in a first direction positions the shutter to overlap one or more of the plurality of vertical blades, and movement of the shutter in a second direction opposite the first direction positions the shutter to overlap a different one or more of the plurality of vertical blades.

### TECHNICAL FIELD

The present specification generally relates to air registers for vehicles and, more specifically, air registers having an adjustable shutter for directing airflow.

### BACKGROUND

Air registers in vehicles typically include a plurality of vertical vanes that are selectively adjustable to direct airflow in a plurality of directions in a width direction or lateral direction of the vehicle. For example, the vertical vanes may be oriented toward the left to direct airflow to the left and to the right to direct airflow to the right. However, this results in numerous moving components to facilitate each vertical vane being simultaneously rotated. Additionally, as air flows through the air register, some of the air may contact a side wall of the air register and be redirected out of the air register. This redirected air affects a flow direction of the remaining air flowing through the air register such that a cumulative angle at which the air flows through the air register is not aligned with a selected direction of the vertical air blades. Rather, the air flows more toward a center of the air register rather than the selected direction.

Accordingly, a need exists for improved air registers that provides fewer moving parts and more accurate airflow through the air registers and, thus, a reduced risk of part failure, reduced manufacturing costs and, a greater range for which air may be directed out of the air registers.

### SUMMARY

In one embodiment, an air register includes: a housing defining a rear opening and a front opening; a blade member provided within the housing and including a plurality of vertical blades; and a shutter located between the blade member and the front opening of the housing, the shutter being slidably movable relative to the housing, wherein translation of the shutter in a vehicle lateral direction controls a flow of air through the plurality of vertical blades.

In another embodiment, a vehicle includes: a dashboard; and an air register provided within the dashboard, the air register including: a housing defining a rear opening and a front opening; a blade member provided within the housing and including a plurality of vertical blades; and a shutter located between the blade member and the front opening of the housing, the shutter being slidably movable relative to the housing, wherein translation of the shutter in a vehicle lateral direction controls a flow of air through the plurality of vertical blades.

In yet another embodiment, a method of operating an air register includes a housing defining a rear opening and a front opening, a blade member provided within the housing and including a plurality of vertical blades, and a shutter located between the blade member and the front opening of the housing, the shutter being slidably movable relative to the housing, the method comprising: directing a flow of air into the housing through the rear opening; translating the shutter in a vehicle lateral direction to control the flow of air through the plurality of vertical blades; and permitting the flow of air to exit the housing through the front opening.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a partial front view of a passenger compartment of a vehicle including a plurality of air registers, according to one or more embodiments shown and described herein;

FIG. 2 schematically depicts a partial perspective view of the air register, according to one or more embodiments shown and described herein;

FIG. 3 schematically depicts an exploded perspective view of the air register, according to one or more embodiments shown and described herein;

FIG. 4A schematically depicts a perspective view of a push knob of the air register in a center position relative to a shutter of the air register, according to one or more embodiments shown and described herein;

FIG. 4B schematically depicts a perspective view of the push knob of the air register in an upward position relative to the shutter of the air register, according to one or more embodiments shown and described herein;

FIG. 4C schematically depicts a perspective view of the push knob of the air register in a downward position relative to the shutter of the air register, according to one or more embodiments shown and described herein;

FIG. 5 schematically depicts a perspective view of a blade member of the air register fixed to a lower housing portion of the air register, according to one or more embodiments shown and described herein;

FIG. 6 schematically depicts a partial top view of the air register with the shutter in a center position, according to one or more embodiments shown and described herein;

FIG. 7 schematically depicts a partial top view of the air register with the shutter in an intermediate left position, according to one or more embodiments shown and described herein;

FIG. 8 schematically depicts a partial top view of the air register with the shutter in a complete left position, according to one or more embodiments shown and described herein;

FIG. 9 schematically depicts a partial top view of the air register with the shutter in an intermediate right position, according to one or more embodiments shown and described herein; and

FIG. 10 schematically depicts a partial top view of the air register with the shutter in a complete right position, according to one or more embodiments shown and described herein.

### DETAILED DESCRIPTION

Embodiments described herein are directed to air registers including a housing defining a rear opening and a front opening, a blade member provided within the housing and including a plurality of vertical blades, and a shutter located between the blade member and the front opening of the housing, the shutter being slidably movable relative to the housing. Translation of the shutter in a vehicle lateral direction controls a flow of air through the plurality of vertical blades. The blade member includes a plurality of vertical blades. Movement of the shutter in a first direction positions the shutter to overlap one or more of the plurality of vertical blades, and movement of the shutter in a second direction opposite the first direction positions the shutter to overlap a different one or more of the plurality of vertical blades.

Various embodiments of the air register and the operation of the air register are described in more detail herein. Whenever possible, the same reference numerals will be used throughout the drawings to refer to the same or like parts.

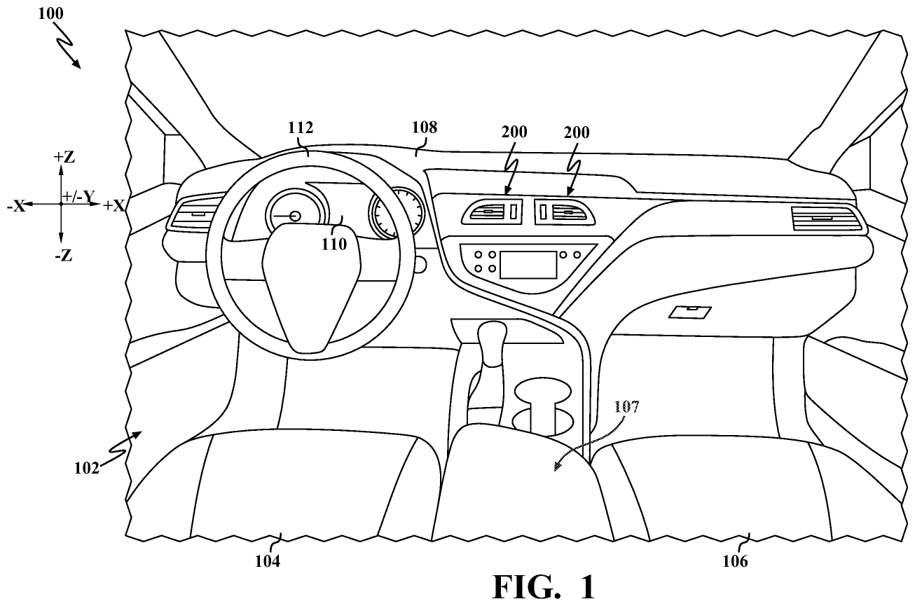

As used herein, the term “vehicle longitudinal direction” refers to the forward-rearward direction of the vehicle (i.e., in the +/−Y direction of the coordinate axes depicted in FIG. 1). Specifically, “rearward” is defined as the positive Y direction of the coordinate axes shown in the drawings, and “forward” is defined as the negative Y direction of the coordinate axes shown in the drawings. The term “vehicle lateral direction” refers to the cross-vehicle direction (i.e., in the +/−X direction of the coordinate axes depicted in FIG. 1), and is transverse to the vehicle longitudinal direction. Specifically, “right” is defined as the positive X direction of the coordinate axes shown in the drawings, and “left” is defined as the negative X direction of the coordinate axes shown in the drawings. The term “vehicle vertical direction” refers to the upward-downward direction of the vehicle (i.e., in the +/−Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings. Although the air register and components thereof are described with relation to the vehicle longitudinal direction, the vehicle lateral direction, and the vehicle vertical direction, it should be appreciated that the air register may be entirely rotated in a clockwise direction or a counterclockwise direction such that the “vehicle lateral direction” extends in the up/down direction and the “vehicle vertical direction” extends in the left/right direction. Accordingly, the directions referred to herein may not be tied directly to the vehicle itself.

Referring now to FIG. 1, a vehicle 100 is illustrated according to one or more embodiments described herein. The vehicle 100 includes a passenger compartment 102 in which a driver seat 104 and a front passenger seat 106 are provided with a center console 107 provided therebetween. The vehicle 100 includes a dashboard 108 provided in front of the driver seat 104 and the front passenger seat 106. An instrument panel 110 is provided within the dashboard 108 and a steering wheel 112 is provided in front of the driver seat 104 extending in front of the instrument panel 110. As shown, the vehicle 100 includes a plurality of air registers 200 provided within the dashboard 108. However, it should be appreciated that the location of the air registers 200 is not limited to the specific location illustrated in FIG. 1. Rather, one or more air registers 200 may alternatively or additionally be provided at any other suitable location of the vehicle 100 such as, for example, in a rear portion of the passenger compartment 102 of the vehicle 100 located behind the driver seat 104 and the front passenger seat 106, on a side door of the vehicle 100, on the rear of the center console 107, and the like.

As shown in FIG. 1, the vehicle 100 is provided as an automobile which includes coupes, sedans, minivans, trucks, crossovers, hybrids, and sports utility vehicles. However, the air register 200 is not limited to automobiles. In embodiments, the air register 200 may be provided in any vehicle such as a watercraft, aircraft, or the like.

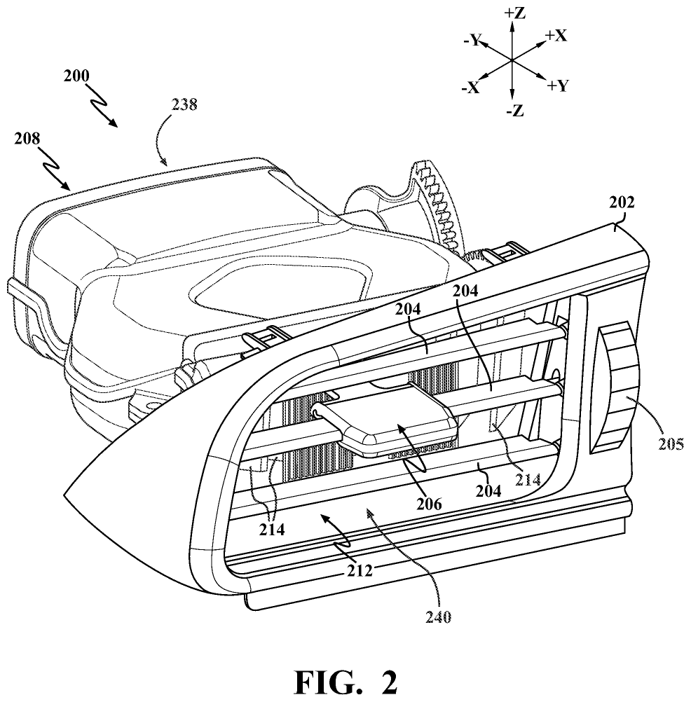

Referring now to FIG. 2, one of the air registers 200 of the vehicle 100 of FIG. 1 is shown separate from the vehicle 100 itself. The air register 200 generally includes a frame 202, a plurality of horizontal fins 204 provided within the frame 202, a push knob 206 slidably mounted, in the vehicle lateral direction, on one of the horizontal fins 204 within the frame 202, and a housing 208 provided rearwardly of the frame 202. In embodiments, the frame 202 may be fixed to the housing 208. In other embodiments, the frame 202 and the housing 208 may be individually fixed or coupled to the dashboard 108 of the vehicle 100 of FIG. 1.

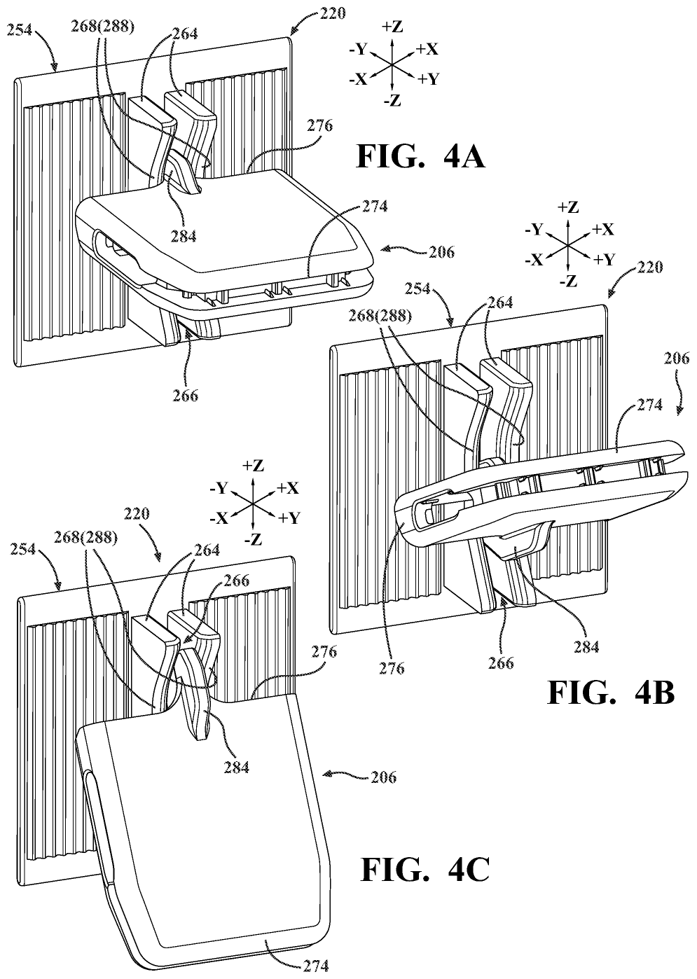

Referring still to FIG. 2, the horizontal fins 204 are elongated planar members extending from opposite sides of a front opening 240 of the housing 208. The horizontal fins 204 control the flow of air flowing through the housing 208 in the vehicle vertical direction. The horizontal fins 204 are interconnected such that pivoting of one of the horizontal fins 204 results in pivoting of each of the horizontal fins 204. It should be appreciated that the horizontal fins 204 may be pivoted by orienting the push knob 206 upward or downward in the vehicle vertical direction, as illustrated in FIGS. 4A-4C and described in more detail herein.

As described in more detail herein, a blade member 212, which includes a plurality of vertical blades 214, is provided within the housing 208. The air register 200 further includes a wheel 205. The wheel 205 is operably coupled to a vent door positionable between an open position and a closed position in any suitable manner including one or more linkages, gears, or the like. Although not shown, the vent door is located at a rear of the housing 208. When the wheel 205 is rotated in a first direction, the vent door is positioned into the open position such that air is permitted to flow into the housing 208 and through the blade member 212. When the wheel 205 is rotated in a second direction opposite the first direction, the vent door is positioned into the closed position such that air is prevented to flow into the housing 208 and through the blade member 212. It should be appreciated that the vent door is also positionable between any number of intermediate positions between the open position and the closed position by rotating the wheel 205 in the first direction or the second direction to control the amount of air that is permitted to flow through the housing 208 and the blade member 212.

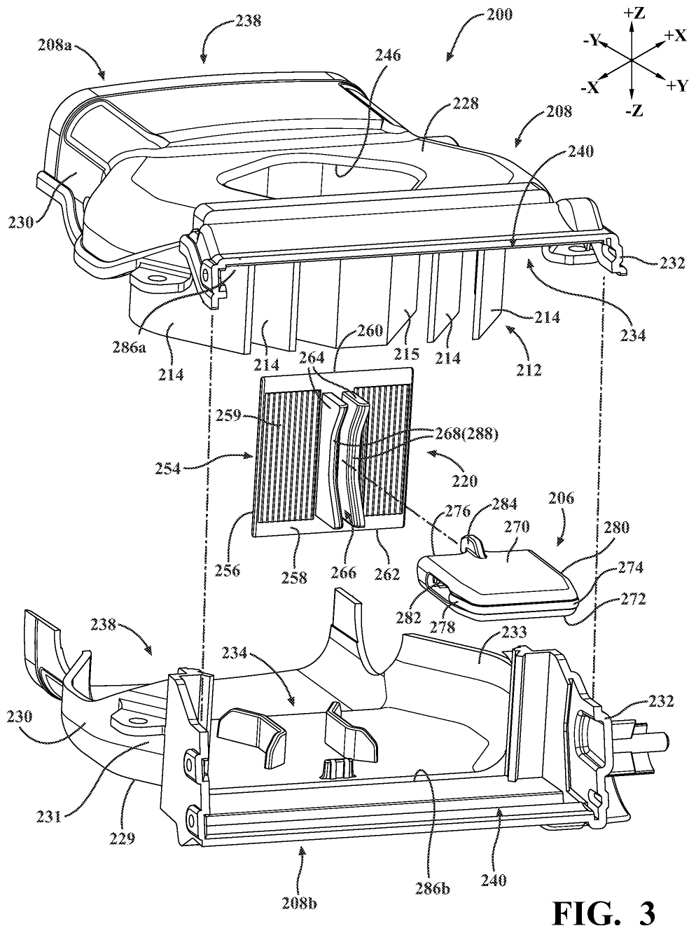

Referring now to FIG. 3, an exploded view of the air register 200 is illustrated. As shown, the air register 200 generally includes the housing 208 the push knob 206, and a shutter 220.

The shutter 220 includes a shutter plate 254 having an inner surface 256, an outer surface 258 opposite the inner surface 256, an upper edge 260, and a lower edge 262 opposite the upper edge 260. In embodiments, a surface texture 259 is provided on the outer surface 258 of the shutter plate 254. The surface texture 259 may serve to reduce glare by light reflecting off the outer surface 258 of the shutter plate 254. In embodiments, the surface texture 259 is a plurality of ribs extending between the upper edge 260 and the lower edge 262. In embodiments, the shutter 220 includes a pair of guides 264, such as a pair of flanges, extending from the outer surface 258 of the shutter plate 254 in a direction opposite the inner surface 256. The guides 264 are spaced apart from one another to define a gap 266 and extend between the upper edge 260 and the lower edge 262 in the vehicle vertical direction. The guides 264 have an outer edge 268 spaced apart from the outer surface 258 of the shutter plate 254. In embodiments, the outer edge 268 of the guides 264 define a concave cutout 288 to permit movement of the push knob 206 relative to the shutter 220, as described in more detail herein. As the guides 264 include the concave cutout 288, a distance from the outer surface 258 of the shutter plate 254 to an outer edge of the guides 264 adjacent the upper edge 260 and a distance from the outer surface 258 of the shutter plate 254 to the outer edge of the guides 264 adjacent the lower edge 262 is greater than a distance from the outer surface 258 of the shutter plate 254 to the outer edge of the guides 264 at a central portion of the guides 264 between the upper edge 260 and the lower edge 262.

The push knob 206 includes an upper surface 270, a lower surface 272 opposite the upper surface 270, a distal end 274, a proximal end 276 opposite the distal end 274, a first side edge 278, and a second side edge 280 opposite the first side edge 278. The first side edge 278 and the second side edge 280 extend between the distal end 274 and the proximal end 276. As used herein, the distal end 274 refers to an end of the push knob 206 furthest from the shutter 220, and the proximal end 276 refers to an end of the push knob 206 closest to the shutter 220. A slot 282 is formed in the push knob 206 extending through the first side edge 278 and the second side edge 280. Accordingly, one of the horizontal fins 204 is permitted to extend through the push knob 206 through the slot 282. In embodiments, a protrusion 284 extends from the proximal end 276 of the push knob 206 in a direction opposite the distal end 274 of the push knob 206.

Referring now to FIGS. 4A-4C, movement of the push knob 206 relative to the shutter 220 is illustrated. As shown in FIG. 4A, the protrusion 284 of the push knob 206 is shown retained, in the vehicle lateral direction, within the gap 266 defined by the guides 264. In embodiments, the protrusion 284 is not fixed to the shutter 220. Rather, the protrusion 284 is permitted to move within the gap 266 in the vehicle vertical direction as the push knob 206 pivots. Specifically, as described herein and as illustrated in FIG. 2, one of the horizontal fins 204 extends through the slot 282 formed in the push knob 206. Accordingly, pivoting of the push knob 206 is restricted to rotational movement of the horizontal fins 204 rotatably coupled to the frame 202 (FIG. 2). As shown in FIG. 4A, the push knob 206 is shown in a center position such that the horizontal fins 204 (FIG. 2) are oriented to direct airflow in a linear direction out of the air register 200 and in a direction parallel to the vehicle longitudinal direction.

As shown in FIG. 4B, the push knob 206 is shown in an upward position relative to the shutter 220. In the upward position, the push knob 206 is pivoted such that the distal end 274 of the push knob 206 is raised and the proximal end 276 of the push knob 206 is lowered. With the push knob 206 in the upward position, the horizontal fins 204 (FIG. 2) are oriented to direct airflow in an upward direction out of the air register 200.

As shown in FIG. 4C, the push knob 206 is shown in a downward position relative to the shutter 220. In the downward position, the push knob 206 is pivoted such that the distal end 274 of the push knob 206 is lowered and the proximal end 276 of the push knob 206 is raised. With the push knob 206 in the downward position, the horizontal fins 204 (FIG. 2) are oriented to direct airflow in a downward direction out of the air register 200.

As described herein, the guides 264 extending from the shutter plate 254 each have an outer edge 268 defining a concave cutout 288. The concave cutout 288 formed in the outer edge 268 of each guide 264 permits the pivoting movement of the push knob 206 by providing a clearance to avoid contacting the proximal end 276 of the push knob 206 during pivoting between the upward position and the downward position.

Although the shutter 220 is depicted as including the guides 264 and the push knob 206 is depicted as including the protrusion 284, it should be appreciated that, in alternative embodiments, the push knob 206 may include a pair of guides extending from the proximal end 276 of the push knob 206 and the shutter 220 may include a protrusion extending from the outer surface 258 of the shutter plate 254. Moreover, alternative structure for maintaining pivoting movement of the push knob 206 relative to the shutter 220 is contemplated as being within the scope of the present disclosure.

Referring again to FIG. 3, the housing 208, depicted as a two-part component, includes an upper wall 228, a lower wall 229, a side wall 230 extending between the upper wall 228 and the lower wall 229, and a front wall 232 formed along a perimeter of the upper wall 228, the lower wall 229, and the side wall 230. The upper wall 228, the lower wall 229, and the side wall 230 define an open interior 234 in which the blade member 212 is positioned. In embodiments, the blade member 212 is fixed within the open interior 234 of the housing 208 in any suitable manner such as by, for example, fasteners, clips, brackets, and the like. In other embodiments, as described in more detail herein, the blade member 212 is formed as an integrally formed, one-piece component with the housing 208. A rear opening 238 is formed in the side wall 230 opposite the front wall 232. Additionally, the side wall 230 defines a first side wall portion 231 provided on one side of the rear opening 238 and a second side wall portion 233 provided on an opposite side of the rear opening 238. A front opening 240 is formed in the front wall 232 such that a flow path may be formed for air to flow through the housing 208, specifically, through the rear opening 238 into the housing 208 and through the front opening 240 out of the housing 208.

Although the housing 208 is depicted as including an upper housing portion 208a and a lower housing portion 208b, it should be appreciated that the housing 208 may be an integrally formed, one-piece component. If provided, the upper housing portion 208a and the lower housing portion 208b may be joined in any suitable manner such as by, for example, fasteners, clips, brackets, and the like.

Referring still to FIG. 3, the vertical blades 214 of the blade member 212 are shown extending from the upper housing portion 208a and, specifically, an inner surface 246 of the upper wall 228 of the housing 208. In embodiments, the vertical blades 214 of the blade member 212 may be fixed to or extend from the lower housing portion 208. In other embodiments, some of the vertical blades 214 of the blade member 212 may be fixed or extend from the upper housing portion 208a and other vertical blades 214 of the blade member 212 may be fixed or extend from the lower housing portion 208b.

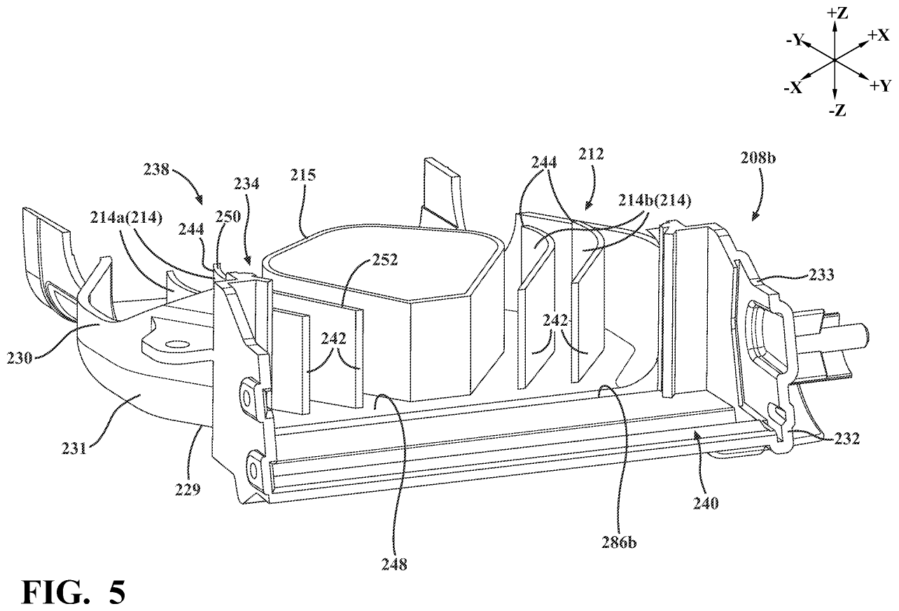

Referring now to FIG. 5, the vertical blades 214 of the blade member 212 are shown extending from an inner surface 248 of the lower wall 229 of the lower housing portion 208b rather than the inner surface 246 of the upper wall 228 of the upper housing portion 208a, as shown in FIG. 3. In either embodiment, it should be appreciated that each vertical blade 214 may include a linear portion 250 and an angular portion 252 extending from an end of the linear portion 250. Each vertical blade 214 has a front end 242 defined by a free end of the linear portion 250 and a rear end 244 opposite the front end 242 defined by a free end of the angular portion 252.

The front end 242 of each vertical blade 214 terminate at a lower groove 286b formed in the inner surface 248 of the lower wall 229 of the lower housing portion 208b. An upper groove 286a is formed in the inner surface 246 of the upper wall 228 of the upper housing portion 208a. As described in more detail herein, the shutter plate 254 (FIG. 3) is received and retained within the lower groove 286b and the upper groove 286a to permit movement of the shutter 220 in the vehicle lateral direction. It should be appreciated that only one of the upper groove 286a and the lower groove 286b may be provided in the housing 208.

The vertical blades 214 are oriented to extend toward a center of the blade member 212. More particularly, the vertical blades 214 include a plurality of first vertical blades 214a and a plurality of second vertical blades 214b. Additionally, a wedge blade 215 is provided between an inner most first vertical blade 214a and an inner most second vertical blade 214b.

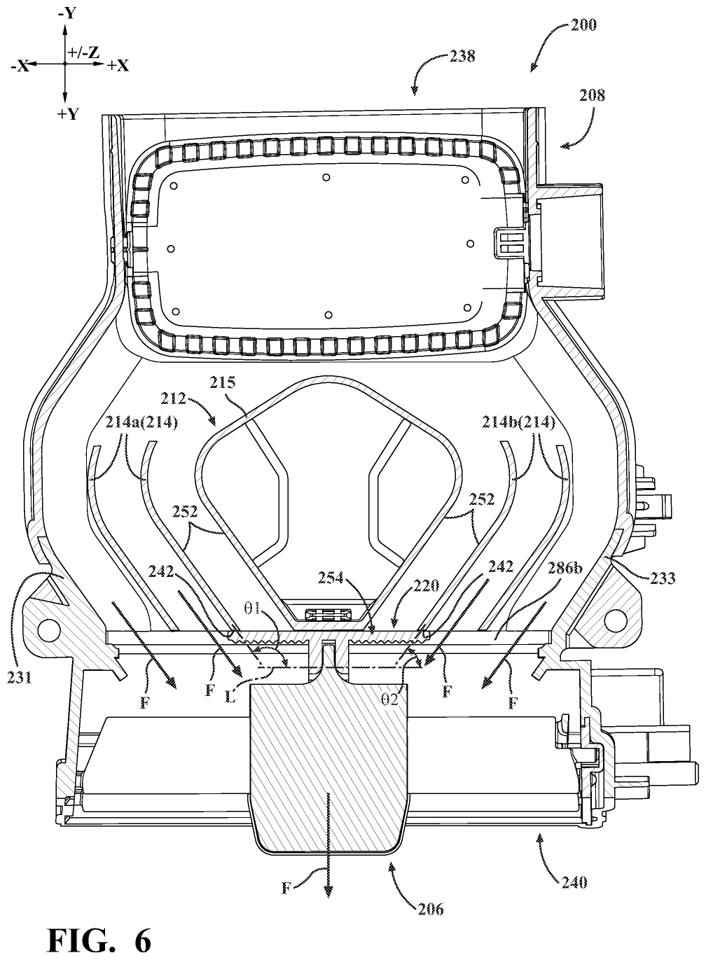

Referring now to FIG. 6, the first vertical blades 214a are located closer to the first side wall portion 231 than to the second side wall portion 233. The first vertical blades 214a are shown extending parallel to one another and generally in a direction toward the second side wall portion 233 in the vehicle rearward direction. The angular portion 252 of the first vertical blades 214a are oriented to extend at a first angle θ1 relative to a lateral axis L extending in the vehicle lateral direction and parallel to the +/−X axis of the coordinate axes depicted in the figures. In embodiments, the first angle θ1 is greater than or equal to 110 degrees and less than or equal to 160 degrees. In embodiments, the first angle θ1 is greater than or equal to 120 degrees and less than or equal to 150 degrees. In embodiments, the first angle θ1 is 135 degrees +/−5%. In embodiments, the first angle θ1 is 135 degrees +/−10%. In embodiments, the first angle θ1 is 135 degrees +/−15%. In embodiments, the first angle θ1 is 135 degrees +/−20%. In other embodiments, the angular portion 252 of the first vertical blades 214a may extend parallel to one another each at a perpendicular angle, i.e., 90 degrees, relative to the lateral axis L. Accordingly, in this embodiment, the first vertical blades 214a extend straight, i.e., parallel to the vehicle longitudinal direction. It should be appreciated that the first angle θ1 may differ than that described herein, but fall within the scope of the present disclosure.

Similarly, referring still to FIG. 6, the second vertical blades 214b are located closer to the second side wall portion 233 than to the first side wall portion 231. The second vertical blades 214b are shown extending parallel to one another and generally in a direction toward the first side wall portion 231 in the vehicle rearward direction. Accordingly, the second vertical blades 214b mirror the first vertical blades 214a. The angular portion 252 of the second vertical blades 214b are oriented to extend at a second angle θ2 relative to the lateral axis L. It should be appreciated that the second angle θ2 is a complementary angle to the first angle θ1 at which the first vertical blades 214a extend. Stated another way, the sum of the first angle θ1 and the second angle θ2 equals 180 degrees. In embodiments, the second angle θ2 is greater than or equal to 20 degrees and less than or equal to 70 degrees. In embodiments, the second angle θ2 is greater than or equal to 30 degrees and less than or equal to 60 degrees. In embodiments, the second angle θ2 is 45 degrees +/−5%. In embodiments, the second angle θ2 is 45 degrees +/−10%. In embodiments, the second angle θ2 is 135 degrees +/−15%. In embodiments, the second angle θ2 is 45 degrees +/−20%. In other embodiments, the angular portion 252 of the second vertical blades 214b may extend parallel to one another each at a perpendicular angle, i.e., 90 degrees, relative to the lateral axis L. Accordingly, in this embodiment, the second vertical blades 214b extend straight, i.e., parallel to the vehicle longitudinal direction. It should be appreciated that the second angle θ2 may differ than that described herein, but fall within the scope of the present disclosure.

Although the blade member 212 is illustrated as including a total of four vertical blades 214, such as two first vertical blades 214a and two second vertical blades 214b, it should be appreciated that the blade member 212 may include any number of first vertical blades 214a and second vertical blades 214b such as, for example, one, three, or more than three. Additionally, the number of first vertical blades 214a does not need to be the same as the number of second vertical blades 214b.

Referring still to FIG. 6, a partial view of the air register 200 is shown with the shutter 220 located in a rearward vehicle longitudinal direction of the blade member 212. Stated another way, the shutter 220 is located between the blade member 212 and the front opening 240 of the housing. As shown in FIG. 6, the shutter 220 is in a center position. Specifically, as shown in FIG. 6, air is depicted by arrows F as flowing between the vertical blades 214 of the blade member 212, and through the front opening 240 of the housing 208. As shown, the shutter 220 is located at the center position in the vehicle lateral direction relative to the blade member 212 such that the shutter plate 254 is positioned to overlap and abut against the front end 242 of the first vertical blades 214a and the second vertical blades 214b. With the shutter 220 in the center position, air is permitted to evenly flow through the first vertical blades 214a and the second vertical blades 214b. Accordingly, the air flowing through the first vertical blades 214a contacts the air flowing through the second vertical blades 214b and is redirected through the front opening 240 of the housing 208 to flow in a substantially vehicle longitudinal direction as opposed to being directed more toward either one of the first side wall portion 231 or the second side wall portion 233 of the housing 208.

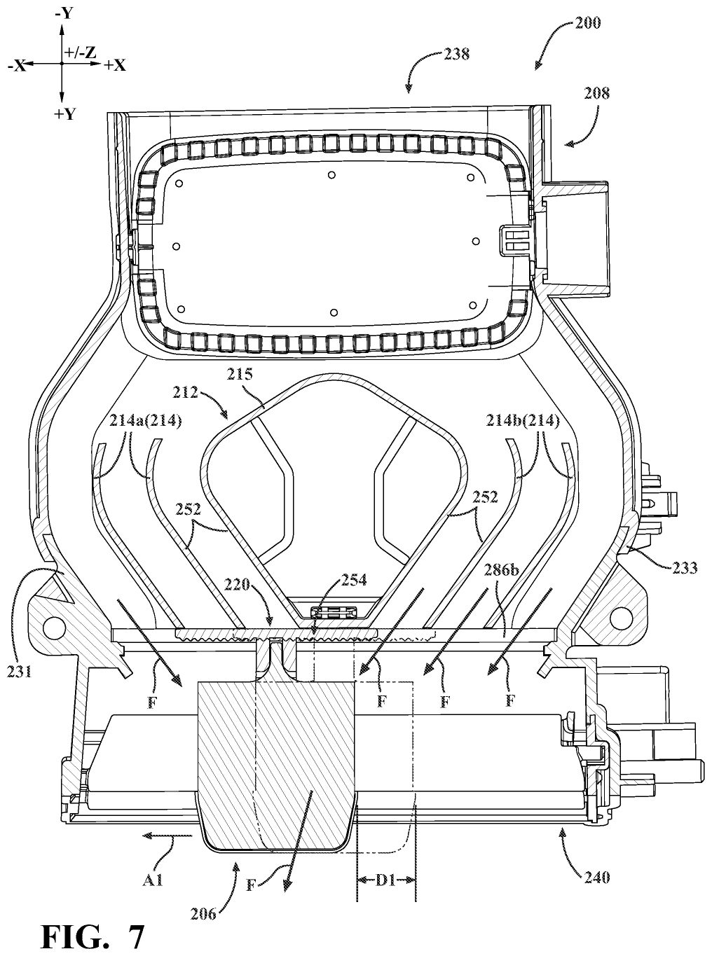

Referring now to FIG. 7, a partial view of the air register 200 is shown with the shutter 220 in an intermediate left position. Specifically, as shown in FIG. 7, air is depicted by arrows F as flowing between the vertical blades 214 of the blade member 212, and through the front opening 240 of the housing 208. As shown, the push knob 206 and the shutter 220 are moved in a first direction A1 in the vehicle lateral direction relative to the blade member 212 to translate the shutter 220 along the upper groove 286a formed in the upper housing portion 208a and the lower groove 286b formed in the lower housing portion 208b and into the intermediate left position. The original position of the push knob 206 and the shutter 220 in the center position is illustrated with dashed lines to better show the amount of translation. The push knob 206 and the shutter 220 translate a first distance D1 in the direction of arrow A1 from the center position to the intermediate left position. In embodiments, the first distance D1 is equal to or greater than 10 millimeters (mm) and less than or equal to 20 mm. In embodiments, the first distance D1 is equal to or greater than 12 mm and less than or equal to 16 mm. In embodiments, the first distance D1 is 14 mm +/−5%. In embodiments, the first distance D1 is 14 mm +/−10%. In embodiments, the first distance D1 is 14 mm +/−15%. In embodiments, the first distance D1 is 14 mm +/−20%. It should be appreciated that the first distance D1 may differ than that described herein, but fall within the scope of the present disclosure.

With the shutter 220 in the intermediate left position, the shutter plate 254 is positioned to overlap a larger portion of the first vertical blades 214a than a portion of the second vertical blades 214b overlapped by the shutter plate 254. As shown With the shutter 220 in the intermediate left position, more air is permitted to flow through the second vertical blades 214b than through the first vertical blades 214a. Accordingly, the additional air flowing through the second vertical blades 214b contacts the reduced air flowing through the first vertical blades 214a such that the air flows through the front opening 240 of the housing 208 in a direction closer to the first side wall portion 231 of the housing 208 than the second side wall portion 233 of the housing 208.

It should be appreciated that the shutter 220 is positionable into a plurality of intermediate left positions based on an amount of translation of the shutter 220, which is dependent on an amount of translation of the push knob 206 in the first direction A1.

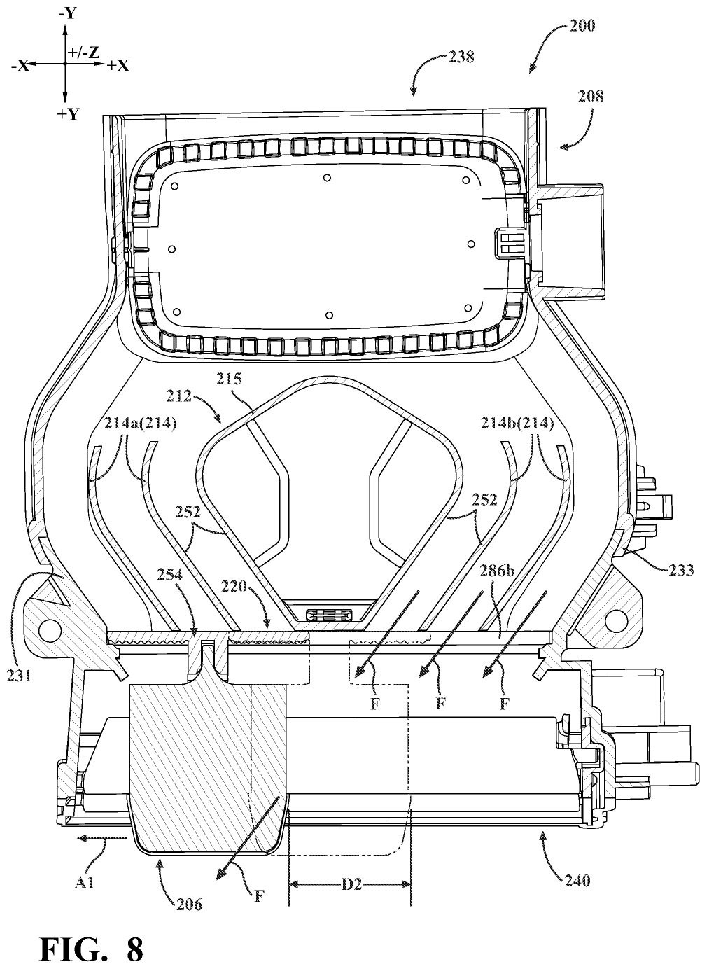

Referring now to FIG. 8, a partial view of the air register 200 is shown with the shutter 220 in a complete left position. Specifically, as shown in FIG. 8, air is depicted by arrows F as flowing between the vertical blades 214 of the blade member 212, and through the front opening 240 of the housing 208. As shown, the push knob 206 is moved further in the first direction A1 in the vehicle lateral direction relative to the blade member 212 to further translate the shutter 220 along the upper groove 286a formed in the upper housing portion 208a and the lower groove 286b formed in the lower housing portion 208b and into the complete left position. The push knob 206 and the shutter 220 translate a second distance D2 in the direction of arrow A1 from the center position to the complete left position. In embodiments, the second distance D2 is equal to or greater than 20 mm and less than or equal to 40 mm. In embodiments, the second distance D2 is equal to or greater than 24 mm and less than or equal to 32 mm. In embodiments, the second distance D2 is 28 mm +/−5%. In embodiments, the second distance D2 is 28 mm +/−10%. In embodiments, the second distance D2 is 28 mm +/−15%. In embodiments, the second distance D2 is 28 mm +/−20%. It should be appreciated that the second distance D2 may differ than that described herein, but fall within the scope of the present disclosure.

With the shutter 220 in the complete left position, the shutter plate 254 abuts against the first side wall portion 231 of the housing 208. Additionally, the shutter plate 254 completely overlaps the first vertical blades 214a and does not overlap any portion of the second vertical blades 214b. With the shutter 220 in the complete left position, air is permitted to flow through the second vertical blades 214b and is inhibited from flowing through the first vertical blades 214a. Accordingly, the air flowing through the second vertical blades 214b is not impeded by air flowing through the first vertical blades 214a and thus flows through the front opening 240 of the housing 208 in a direction closer to the first side wall portion 231 of the housing 208 than the second side wall portion 233 of the housing 208, as compared to the direction of air flowing through the front opening 240 of the housing 208 when the shutter 220 is in the intermediate left position.

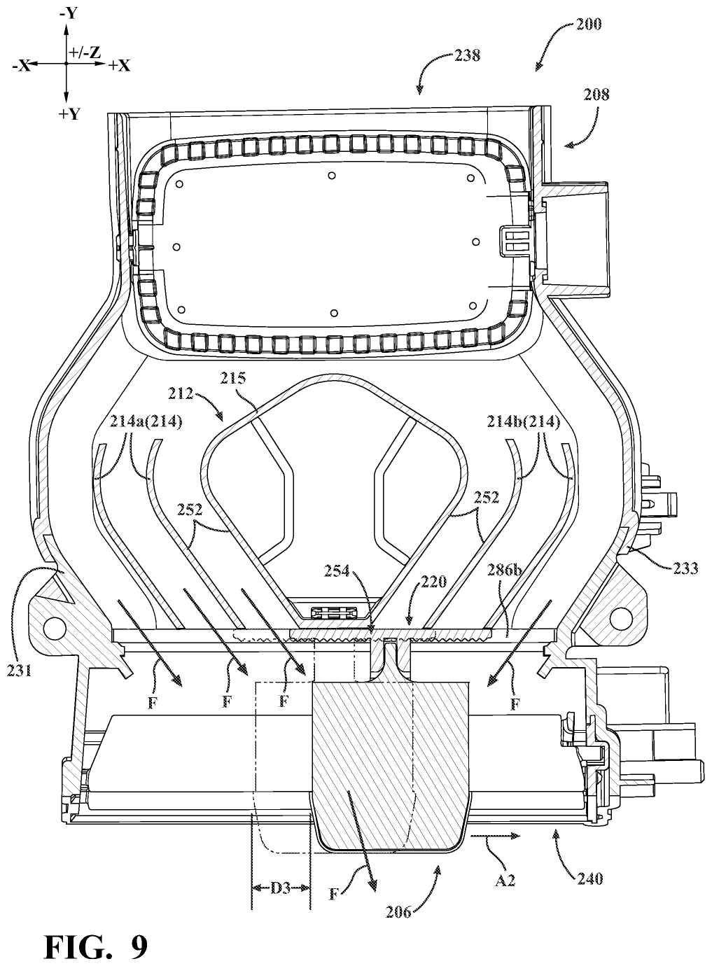

Referring now to FIG. 9, a partial view of the air register 200 is shown with the shutter 220 in an intermediate right position. Specifically, as shown in FIG. 9, air is depicted by arrows F as flowing between the vertical blades 214 of the blade member 212, and through the front opening 240 of the housing 208. As shown, the push knob 206 and the shutter 220 are moved in a second direction A2 in the vehicle lateral direction opposite the first direction A1 (FIG. 7) relative to the blade member 212 to translate the shutter 220 along the upper groove 286a formed in the upper housing portion 208a and the lower groove 286b formed in the lower housing portion 208b and into the intermediate right position. The push knob 206 and the shutter 220 translate a third distance D3 in the direction of arrow A2 from the center position to the intermediate right position. In embodiments, the third distance D3 is equal to or greater than 10 mm and less than or equal to 20 mm. In embodiments, the third distance D3 is equal to or greater than 12 mm and less than or equal to 16 mm. In embodiments, the third distance D3 is 14 mm +/−5%. In embodiments, the third distance D3 is 14 mm +/−10%. In embodiments, the third distance D3 is 14 mm +/−15%. In embodiments, the third distance D3 is 14 mm +/−20%. In embodiments, the third distance D3 is equal to the first distance D1.

With the shutter 220 in the intermediate right position, the shutter plate 254 overlaps a larger portion of the second vertical blades 214b than a portion of the first vertical blades 214a overlapped by the shutter plate 254. With the shutter 220 in the intermediate right position, more air is permitted to flow through the first vertical blades 214a than through the second vertical blades 214b. Accordingly, the additional air flowing through the first vertical blades 214a contacts the reduced air flowing through the second vertical blades 214b such that the air flows through the front opening 240 of the housing 208 in a direction closer to the second side wall portion 233 of the housing 208 than the first side wall portion 231 of the housing 208.

It should be appreciated that the shutter 220 is positionable into a plurality of intermediate right positions based on an amount of translation of the shutter 220, which is dependent on an amount of translation of the push knob 206 in the second direction A2.

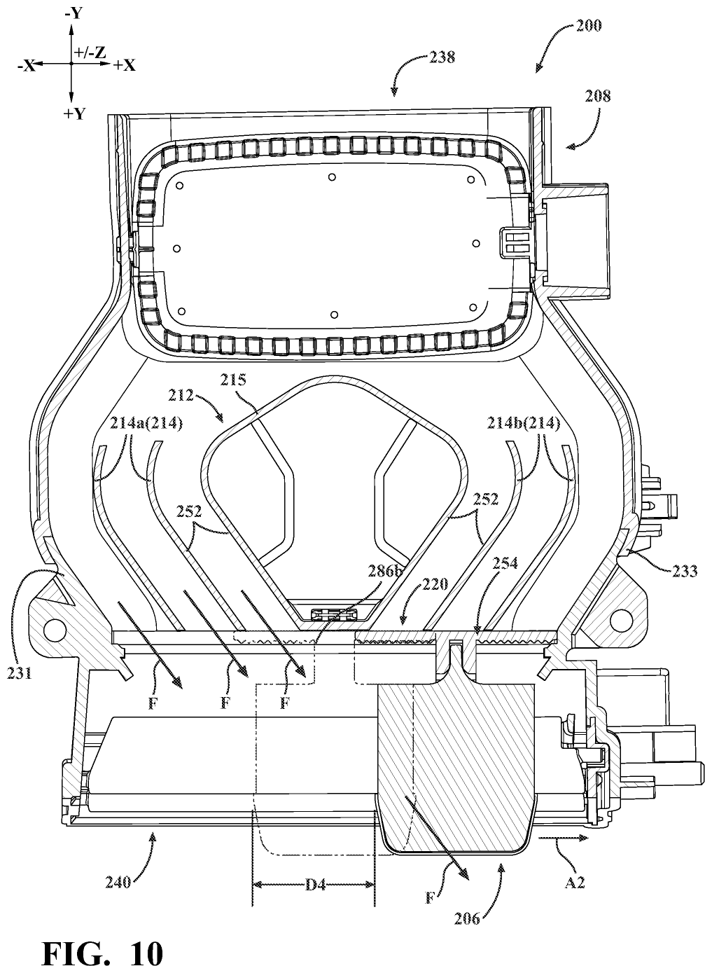

Referring now to FIG. 10, a partial view of the air register 200 is shown with the shutter 220 in a complete right position. Specifically, as shown in FIG. 10, air is depicted by arrows F as flowing between the vertical blades 214 of the blade member 212, and through the front opening 240 of the housing 208. As shown, the push knob 206 is moved further in the second direction A2 in the vehicle lateral direction relative to the blade member 212 to further translate the shutter 220 along the upper groove 286a formed in the upper housing portion 208a and the lower groove 286b formed in the lower housing portion 208b and into the complete right position. The push knob 206 and the shutter 220 translate a fourth distance D4 in the direction of arrow A2 from the center position to the complete right position. In embodiments, the fourth distance D4 is equal to or greater than 20 mm and less than or equal to 40 mm. In embodiments, the fourth distance D4 is equal to or greater than 24 mm and less than or equal to 32 mm. In embodiments, the fourth distance D4 is 28 mm +/−5%. In embodiments, the fourth distance D4 is 28 mm +/−10%. In embodiments, the fourth distance D4 is 28 mm +/−15%. In embodiments, the fourth distance D4 is 28 mm +/−20%. In embodiments, the fourth distance D4 is equal to the second distance D2.

With the shutter 220 in the complete right position, the shutter plate 254 abuts against the second side wall portion 233 of the housing 208. Additionally, the shutter plate 254 completely overlaps the second vertical blades 214b and does not overlap any portion of the first vertical blades 214a. With the shutter 220 in the complete right position, air is permitted to flow through the first vertical blades 214a and inhibited from flowing through the second vertical blades 214b. Accordingly, the air flowing through the first vertical blades 214a is not impeded by air flowing through the second vertical blades 214b and thus flows through the front opening 240 of the housing 208 in a direction closer to the second side wall portion 233 of the housing 208 than the first side wall portion 231 of the housing 208, as compared the direction of air flowing through the front opening 240 of the housing 208 when the shutter 220 is in the intermediate right state.

Operation of the air register 200 is described herein with reference to the shutter 220 moving from the center position to the complete left position by translating the push knob 206 in the first direction Al, or moving from the center position to the complete right position by translating the push knob 206 in the second direction A2. However, it should be appreciated that operation of the shutter 220 returning to the center position from either the complete left position or the complete right position is achieved by moving the push knob 206 in an opposite direction.

From the above, it is to be appreciated that defined herein is an air register including a housing defining a rear opening and a front opening, a blade member provided within the housing and including a plurality of vertical blades, and a shutter located between the blade member and the front opening of the housing, the shutter being slidably movable relative to the housing. Translation of the shutter in a vehicle lateral direction controls a flow of air through the plurality of vertical blades. The blade member includes a plurality of vertical blades. Movement of the shutter in a first direction positions the shutter to overlap one or more of the plurality of vertical blades, and movement of the shutter in a second direction opposite the first direction positions the shutter to overlap a different one or more of the plurality of vertical blades.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An air register comprising:
a housing defining a rear opening and a front opening;
a blade member provided within the housing and including a plurality of vertical blades; and
a shutter located between the blade member and the front opening of the housing, the shutter being slidably movable relative to the housing,
wherein translation of the shutter in a vehicle lateral direction controls a flow of air through the plurality of vertical blades.

2. The air register of claim 1, wherein the plurality of vertical blades comprises a plurality of first vertical blades extending parallel to one another and in a first direction toward a center of the housing, and a plurality of second vertical blades extending parallel to one another and in a second direction opposite the first direction toward the center of the housing.

3. The air register of claim 2, wherein each of the plurality of vertical blades includes a linear portion and an angular portion extending from an end of the linear portion.

4. The air register of claim 3, wherein the plurality of first vertical blades are mirror images of the plurality of second vertical blades.

5. The air register of claim 1, wherein:
a groove is formed in the housing; and
the shutter is slidably movable within the groove.

6. The air register of claim 5, wherein the plurality of vertical blades terminate at the groove.

7. The air register of claim 5, wherein the groove is a lower groove formed in a lower housing portion of the housing and further comprises an upper groove formed in an upper housing portion of the housing.

8. The air register of claim 1, further comprising:
a horizontal fin; and
a push knob slidably engaging the horizontal fin,
wherein the push knob engages the shutter to facilitate movement of the shutter in the vehicle lateral direction.

9. The air register of claim 8, wherein:
the shutter includes a pair of guides spaced apart from one another to define a gap;
the push knob includes a protrusion received within the gap; and
the push knob is movable relative to the shutter between an upward position and a downward position as the protrusion of the push knob slides within the gap of the shutter.

10. The air register of claim 9, wherein the pair of guides include an outer edge defining a concave cutout to permit movement of the push knob relative to the shutter between the upward position and the downward position.

11. The air register of claim 2, wherein:
movement of the shutter in a first direction positions the shutter to overlap the plurality of first vertical blades; and
movement of the shutter in a second direction opposite the first direction positions the shutter to overlap the plurality of second vertical blades.

12. A vehicle comprising:
a dashboard; and
an air register provided within the dashboard, the air register comprising:
a housing defining a rear opening and a front opening;
a blade member provided within the housing and including a plurality of vertical blades; and
a shutter located between the blade member and the front opening of the housing, the shutter being slidably movable relative to the housing,
wherein translation of the shutter in a vehicle lateral direction controls a flow of air through the plurality of vertical blades.

13. The vehicle of claim 12, wherein the plurality of vertical blades comprises a plurality of first vertical blades extending parallel to one another and in a first direction toward a center of the housing, and a plurality of second vertical blades extending parallel to one another and in a second direction opposite the first direction toward the center of the housing.

14. The vehicle of claim 12, wherein:
a groove is formed in the housing;
the shutter is slidably movable within the groove; and
the plurality of vertical blades terminate at the groove.

15. The vehicle of claim 12, further comprising:
a horizontal fin; and
a push knob slidably engaging the horizontal fin,
wherein the push knob engages the shutter to facilitate movement of the shutter in the vehicle lateral direction.

16. The vehicle of claim 15, wherein:
the shutter includes a pair of guides spaced apart from one another to define a gap;
the push knob includes a protrusion received within the gap; and
the push knob is movable relative to the shutter between an upward position and a downward position as the protrusion of the push knob slides within the gap of the shutter.

17. The vehicle of claim 13, wherein:
movement of the shutter in a first direction positions the shutter to overlap the plurality of first vertical blades; and
movement of the shutter in a second direction opposite the first direction positions the shutter to overlap the plurality of second vertical blades.

18. A method of operating an air register comprising a housing defining a rear opening and a front opening, a blade member provided within the housing and including a plurality of vertical blades, and a shutter located between the blade member and the front opening of the housing, the shutter being slidably movable relative to the housing, the method comprising:
directing a flow of air into the housing through the rear opening;
translating the shutter in a vehicle lateral direction to control the flow of air through the plurality of vertical blades; and
permitting the flow of air to exit the housing through the front opening.

19. The method of claim 18, wherein:
translating the shutter comprises translating the shutter within a groove formed in the housing; and
the plurality of vertical blades terminate at the groove.

20. The method of claim 18, wherein:
movement of the shutter in a first direction positions the shutter to overlap one or more of the plurality of vertical blades; and
movement of the shutter in a second direction opposite the first direction positions the shutter to overlap a different one or more of the plurality of vertical blades.
